(19) United States
(12) Patent Application Publication
(10) Pub. No.: US 2016/0353931 A1
(43) Pub. Date: Dec. 8, 2016

(54) COFFEE GRINDING DEVICE

(71) Applicant: JIE-CHI LIU, Changhua County (TW)

(72) Inventor: JIE-CHI LIU, Changhua County (TW)

(21) Appl. No.: 15/011,416

(22) Filed: Jan. 29, 2016

(30) Foreign Application Priority Data
Jun. 8, 2015 (TW) 104209064

(51) Int. Cl. A47J 42/10; A47J 31/42; A47J 42/46

(52) U.S. Cl. CPC A47J 42/10; A47J 42/46; A47J 31/42

(57) ABSTRACT

A coffee grinding device includes a base, a tubular part connected to the top of the base, and a driving member received in the tubular part and driven by the base. A male grinder is connected to the driving member with a female grinder adjustably located above the male grinder. A threaded tube is threadedly connected to the tubular part and defines a gap between the underside of the threaded tube and the female grinder to adjust the sizes of coffee beans to be ground between the male and female grinders. The coffee beans are ground between the male and female grinders, and collected in the base. A cap is directly mounted to the base and receives a filter therein. The ground coffee powder is put in the filter and hot water is poured into the filter to make coffee which flows into the base.

### BACKGROUND OF THE INVENTION

1. Fields of the Invention

The present invention relates to a coffee grinding device, and more particularly, to a multiple-function coffee grinding device equipped with a grinding device.

2. Descriptions of Related Art

The conventional cup for enjoying a cup of coffee can be made of different materials and have different styles. The coffee is ready to enjoy by simply pouring coffee in the cup. All of the conventional cups have only one function which is not related to the ways that the coffee is made. Instant coffee powder is convenient for use, but is deemed to be lack of characters. Some users use coffee makers to grind coffee beans into powder which is then put into coffee making machine to become coffee. For individual users, to purchase a coffee making machine may not be the priority choice.

The conventional coffee makers require a driving shaft, a spring or a bolt to position and drive the grinder. The driving shaft, spring or bolt makes the assembling processes to be complicated.

The present invention intends to provide a coffee grinding device which allows the users to grind coffee beans to make a cup of coffee with satisfied flavor. To eliminate the shortcomings of the conventional coffeemakers, the present invention provides a coffee grinding device without central principal axis, and the invention meets all of the patentable requirements.

### SUMMARY OF THE INVENTION

The present invention relates to a coffee grinding device and comprises a base having an open top and a closed bottom. Multiple first threads are defined in the outside of the top end of the base. A first engaging portion is defined in the inner periphery of the top end of the base. A tubular part has multiple second threads defined in the inner periphery thereof and the second threads are located above the lower end of the tubular part. Multiple third threads are defined in the inner periphery of the lower end of the tubular part. A flange extends from the inner periphery of the tubular part and is located between the second threads and the third threads. The third threads of the tubular part are engaged with the first threads of the base.

A driving member has an open bottom, and a second engaging portion is formed on the outer periphery of the driving member. A support surface is transversely formed in the top section of the driving member and multiple slots are defined through the support surface and communicate with the open bottom. A third engaging portion extends from the top of the support face. A skirt portion extends outward from the outer periphery of the driving member. The diameter of the skirt portion is larger than that of the second engaging portion. The driving member is inserted into the tubular part and the underside of the skirt portion is rested on the flange of the tubular part.

A male grinder has a fourth engaging portion defined in the underside thereof. The fourth engaging portion is removably engaged with the third engaging portion of the driving member. The male grinder has a tapered surface on the outer periphery thereof, and multiple first grinding pieces extend from the tapered surface. When the base is rotated, the driving member is rotated by the base, and the male grinder is rotated by the driving member. A collar has multiple fourth threads defined in the outer periphery thereof. The collar is received in the tubular part by engaging the fourth threads with the second threads of the tubular part. The collar is located above the driving member and has a fifth engaging portion defined in the inner periphery thereof. A female grinder has a sixth engaging portion formed on the outer periphery thereof. The female grinder is received in the collar, and the sixth engaging portion of the female grinder is engaged with the fifth engaging portion of the collar. The female grinder has third grinding pieces formed in the inner periphery thereof. When the tubular part is rotated, the collar is driven by the tubular part, and the female grinder is rotated by the collar.

A threaded tube has fifth threads defined in the outside thereof and has a touch face defined in the underside thereof. The fifth threads are engaged with the second threads of the tubular part. The touch face adjustably touches the top of the female grinder. The threaded tube has a seventh engaging portion defined in the outside thereof. A cap has a closed top and an open bottom. An eighth engaging portion is formed on the inside of the cap and removably engaged with the seventh engaging potion of the threaded tube. A gap defined between the touch face and the female grinder is adjusted by rotating the cap.

The primary object of the present invention is to provide a coffee grinding device that grinds coffee beans of different sizes.

Another object of the present invention is to provide a coffee grinding device wherein no electric power is needed.

Yet another object of the present invention is to provide a coffee grinding device without central principal axis.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the coffee grinding device of the present invention;

FIG. 2 is an exploded view of the coffee grinding device of the present invention;

FIG. 3 is another exploded view of the coffee grinding device of the present invention;

FIG. 4 shows cross sectional view of each part of the coffee grinding device of the present invention;

FIG. 5 shows cross sectional view of the coffee grinding device of the present invention;

FIG. 6 shows the base and the tubular part are rotated in opposite directions;

FIG. 7 is a cross sectional view of the action disclosed in FIG. 6, the coffee beans are ground by the male and female grinders of the coffee grinding device of the present invention;

FIG. 8 shows that the cap is rotated relative to the tubular part;

FIG. 9 shows that the coffee powder is put in the filter in the cap and coffee is made by pouring hot water into the filter in the cap;

FIG. 10 is a perspective view to show the male grinder;

FIG. 11 is a cross sectional view to show the male grinder;

FIG. 12 is a perspective view to show another embodiment of the male grinder;

FIG. 13 is a cross sectional view to show the male grinder in FIG. 12;

FIG. 14 is a perspective view to show the female grinder;

FIG. 15 is a cross sectional view to show the female grinder;

FIG. 16 is a perspective view to show yet another embodiment of the male grinder;

FIG. 17 is a cross sectional view to show the male grinder in FIG. 16;

FIG. 18 is a perspective view to show a further embodiment of the male grinder, and

FIG. 19 is a cross sectional view to show the male grinder in FIG. 18.

### DETAILED DESCRIPTION OF THE PREFERRED EMBODIMENT

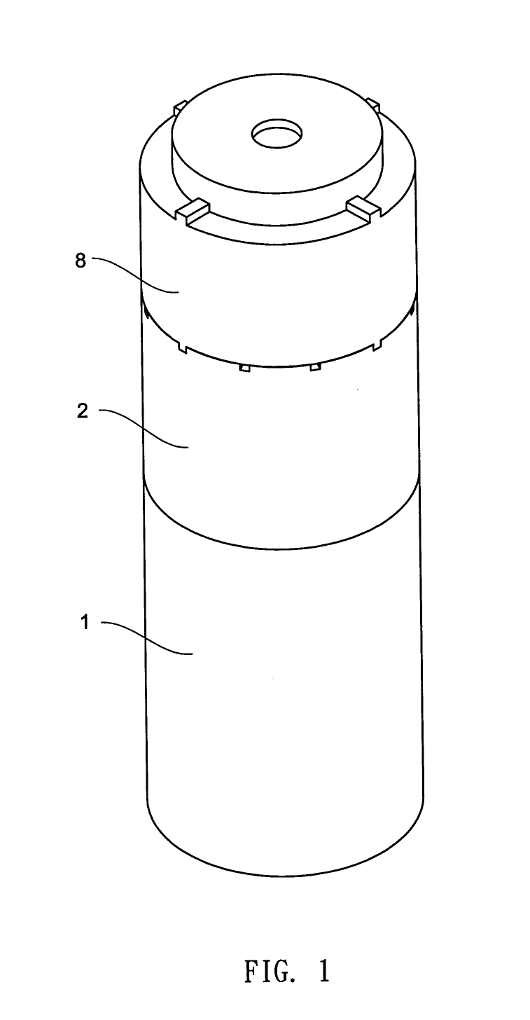

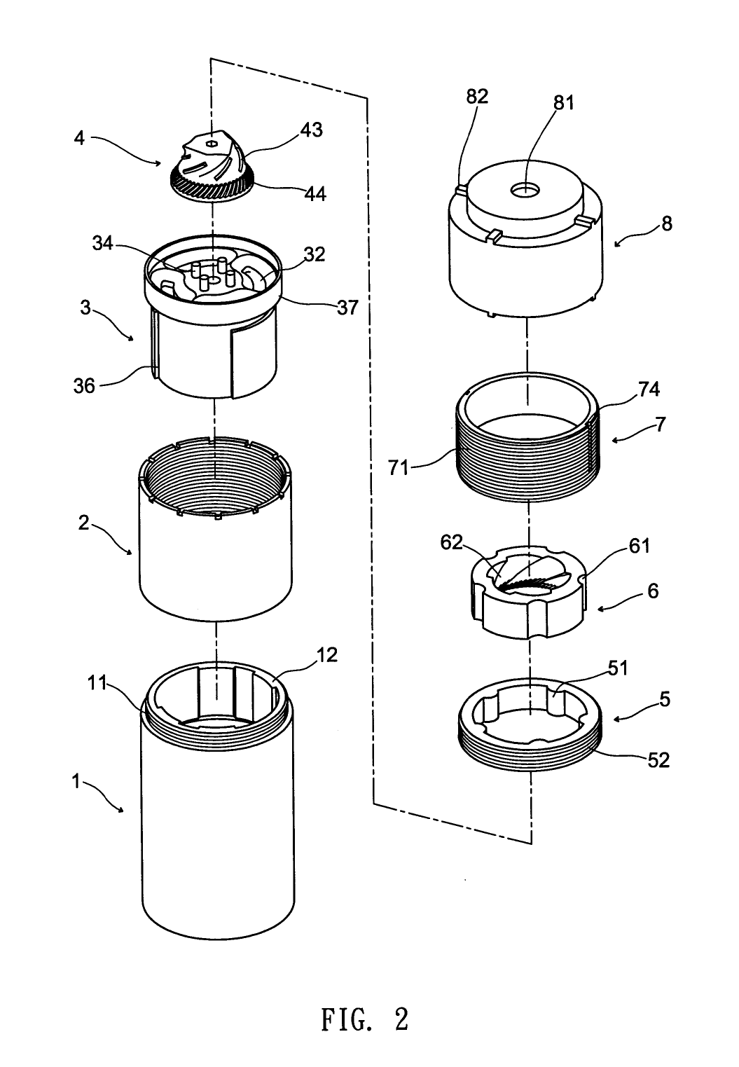

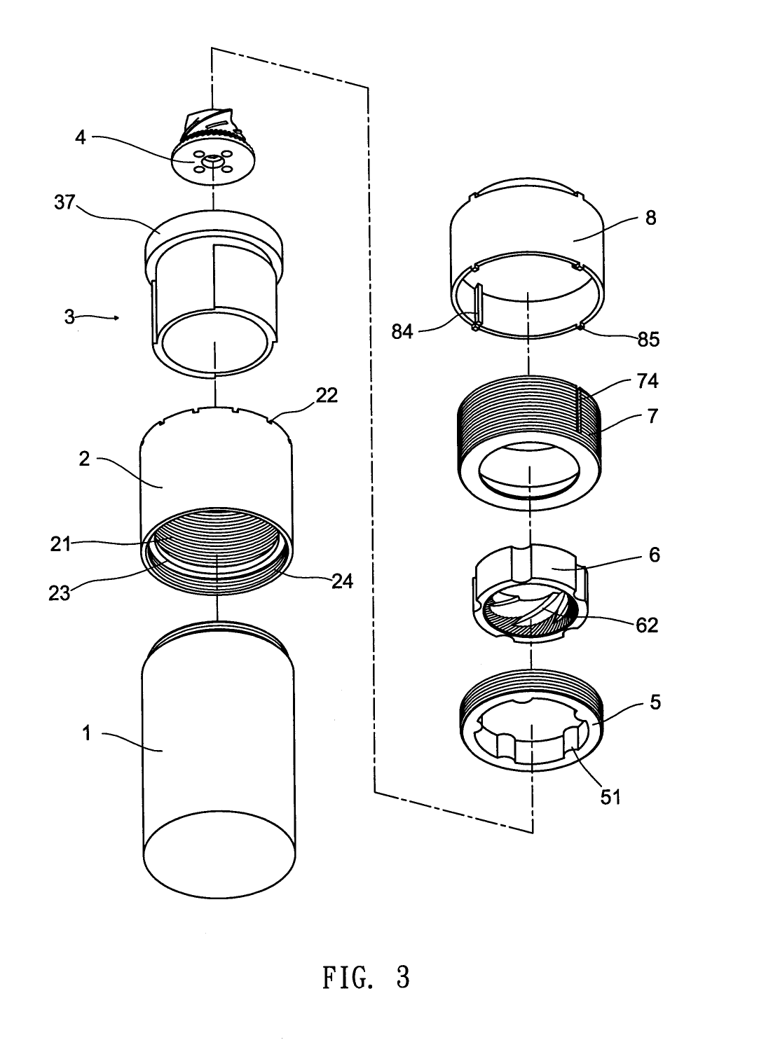

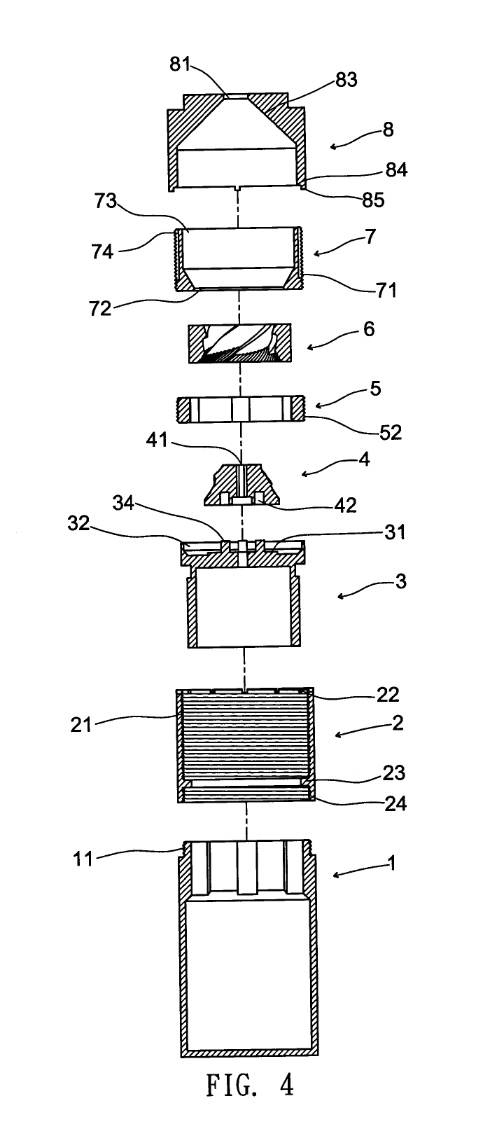

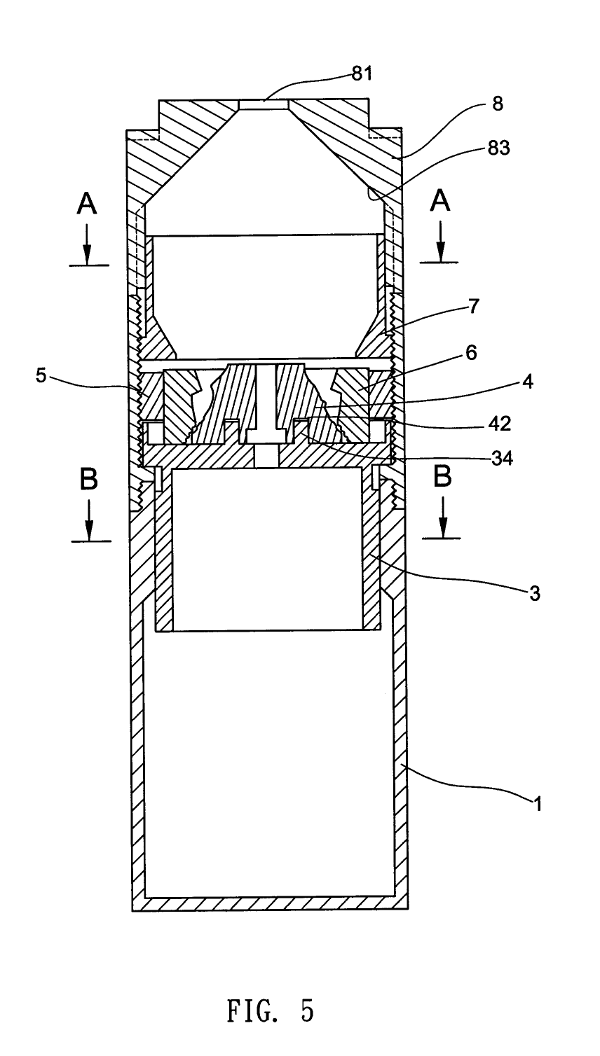

Referring to FIGS. 1 to 5, the coffee grinding device of the present invention comprises a base 1 having an open top and a closed bottom, and the base 1 can be used as a cup. Multiple first threads 11 are defined in the outside of the top end of the base 1, and a first engaging portion is defined in the inner periphery of the top end of the base 1. In the embodiment, the first engaging portion includes multiple ridges 12 extending from the inner periphery of the base 1.

A tubular part 2 has multiple second threads 21 defined in the inner periphery thereof and the second threads 21 are located above the lower end of the tubular part 2. Multiple third threads 24 are defined in the inner periphery of the lower end of the tubular part 2. A flange 23 extends from the inner periphery of the tubular part 2 and is located between the second threads 21 and the third threads 24. The third threads 24 of the tubular part 2 are engaged with the first threads 11 of the base 1 to connect the base 1 and the tubular part 2. Multiple notches 22 are defined in the top edge of the tubular part 2.

A driving member 3 has an open bottom, and a second engaging portion is formed on the outer periphery of the driving member 3. In this embodiment, the second engaging portion includes multiple recesses 36 defined in the outer periphery of the driving member 3. A support surface 31 is transversely formed in the top section of the driving member 3, and multiple slots 32 are defined through the support surface 31 and communicate with the open bottom of the driving member 3. A third engaging portion extends from the top of the support face 31. In this embodiment, the third engaging portion includes multiple rods 34. A skirt portion 37 extends outward from the outer periphery of the driving member 3. The diameter of the skirt portion 37 is larger than that of the second engaging portion. The driving member 3 is inserted into the tubular part 2 and the underside of the skirt portion 37 is rested on the flange 23 of the tubular part 2. The ridges 12 are engaged with the recesses 36.

A male grinder 4 has a fourth engaging portion defined in the underside thereof. In this embodiment, the fourth engaging portion is removably engaged with the third engaging portion of the driving member 3. In this embodiment, the fourth engaging portion includes multiple reception holes 42 in which the rods 34 are inserted. The male grinder 4 has a tapered surface on the outer periphery thereof, and multiple first grinding pieces 43 extend from the tapered surface. The male grinder 4 further has second grinding pieces 44 formed on the tapered surface thereof. The second grinding pieces 44 are located above the first grinding pieces 43, and the number of second grinding pieces 44 is more than the number of the first grinding pieces 43. Each of the first and second grinding pieces 43, 44 are inclined relative to the axis of the male grinder 4. When the base 1 is rotated, the driving member 3 is rotated by the base 1, and the male grinder 4 is rotated by the driving member 3.

A collar 5 has multiple fourth threads 52 defined in the outer periphery thereof, and the collar 5 is received in the tubular part 2 by engaging the fourth threads 52 with the second threads 21 of the tubular part 2. The collar 5 is located above the driving member 3 and has a fifth engaging portion defined in the inner periphery thereof. In this embodiment, the fifth engaging portion includes multiple protrusions 51 extending from the inner periphery of the collar 5.

A female grinder 6 has a sixth engaging portion formed on the outer periphery thereof. The female grinder 6 is received in the collar 5 and simply put to surround the male grinder 4. In this embodiment, the sixth engaging portion includes multiple grooves 61 defined axially in the outer periphery of the female grinder 6, with which the protrusions 51 are axially and slidably engaged. This means that the female grinder 6 is freely moved up and down relative to the male grinder 4 and the protrusions 51 of the collar 5. The female grinder 6 has third grinding pieces 62 formed in the inner periphery thereof. When the tubular part 2 is rotated, the collar 5 is driven by the tubular part 2, and the female grinder 6 is rotated by the collar 5.

A threaded tube 7 has fifth threads 71 defined in the outside thereof and has a touch face 72 defined in the underside thereof. The fifth threads 71 are engaged with the second threads 21 of the tubular part 2. The touch face 72 adjustably touches the top of the female grinder 6. The threaded tube 7 has a seventh engaging portion 74defined in the outside thereof. In this embodiment, the seventh engaging portion includes two locking recesses.

A cap 8 has a closed top and an open bottom. An eighth engaging portion 84 is formed on the inside of the cap 8 and removably engaged with the seventh engaging potion 74 of the threaded tube 7. In this embodiment, the eighth engaging portion includes two ribs which are engaged with the locking recesses. A gap between the touch face 72 and the female grinder 6 is adjusted by rotating the cap 8. The cap 8 has multiple insertions 85 extending axially from the open bottom thereof, and the tubular part 2 has multiple notches 22 defined in the top edge thereof. The insertions 85 are engaged with the notches 22.

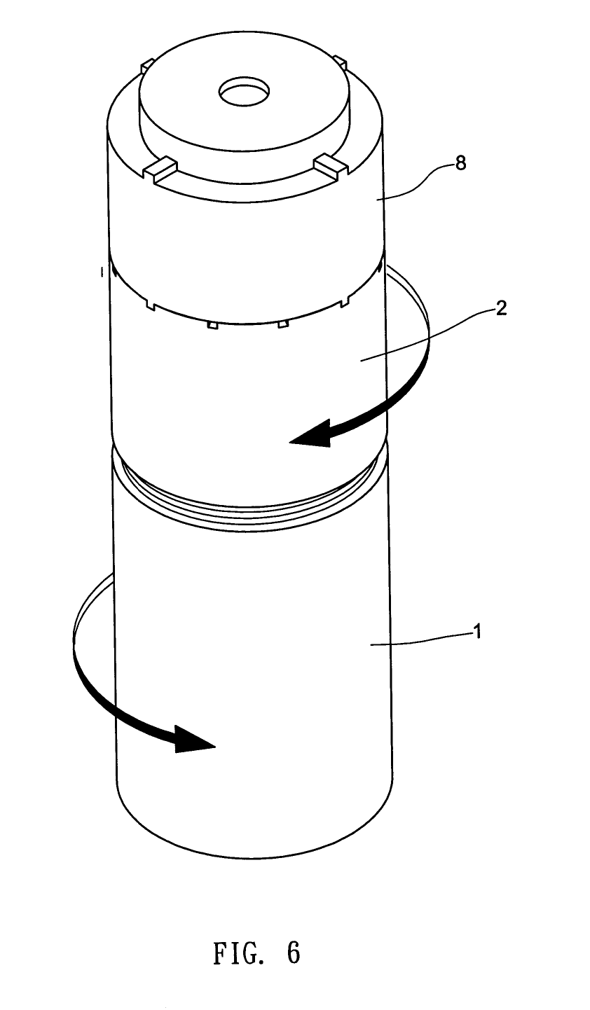

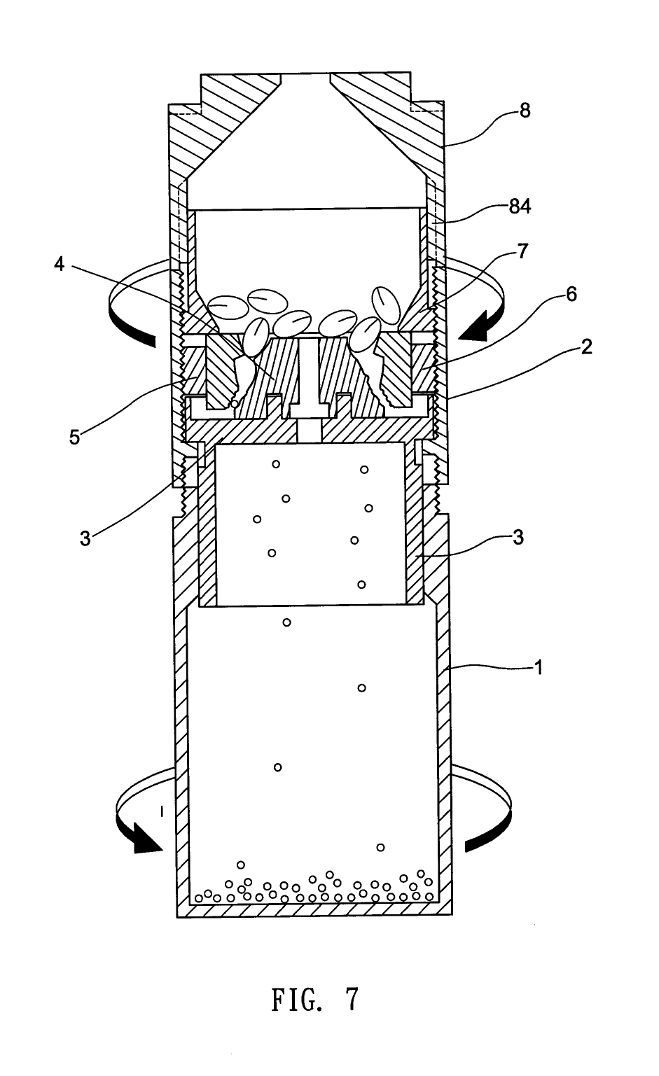

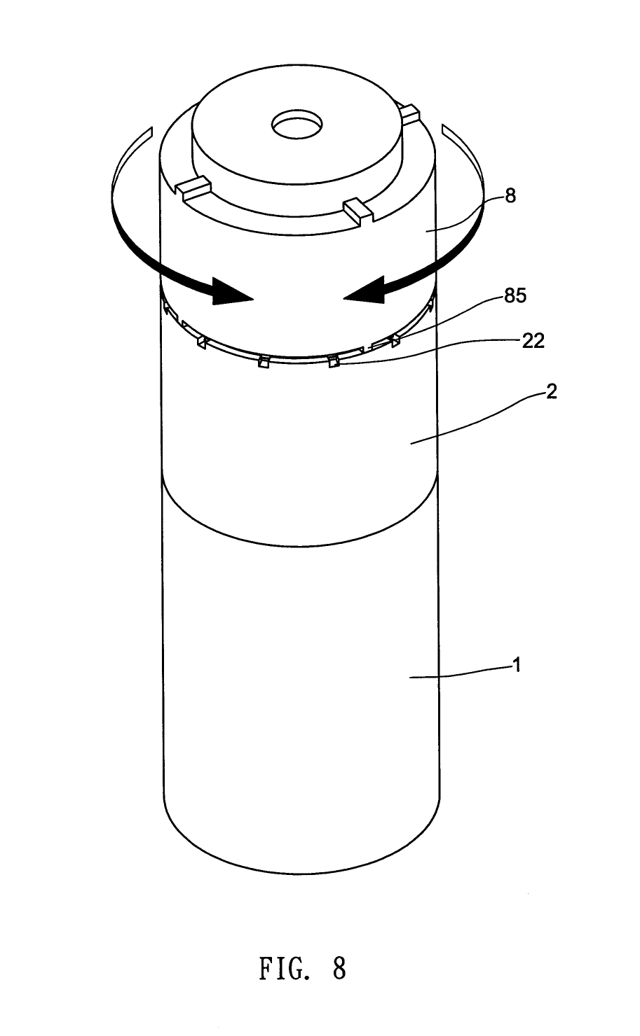

As shown in FIGS. 6 and 7, the user put the coffee beans in the threaded tube 7 and the cap 8 can be lifted to separate the insertions 85 from the notches 22. While the ribs 84 of the cap 8 are engaged with the locking recesses 74 of the threaded tube 7, the cap 8 is rotated to rotate the threaded tube 7 so that the gap between the touch face 72 and the female grinder 6 can be adjusted according to the size of the particles of the coffee powder. When the coffee beans enter into the space between the male grinder 4 and the female grinder 6 to be ground, the desired size of the particles of the coffee powder can be produced by the gap between the touch face 72 and the female grinder 6. The insertions 85 of the cap 8 are then re-engaged with the notches 22 of the tubular part 2, and the insertions 85/the notches 22 perform as an index to indicate the desired size of the particles of the ground coffee powder. When grinding the coffee beans, the base 1 is rotated in one direction, and the driving member 3 is rotated by the base 1 so as to rotate the male grinder 4. The tubular part 2 is rotated in the opposite direction relative to the rotational direction of the base 1, because the collar 5 is connected to the tubular part 2, so that the collar 5 is rotated and drives the female grinder 6 to rotate. Therefore, male and female grinders 4, 6 are rotated in opposite directions and the coffee beans are grounded by the first, second and third grinding pieces 43, 44 and 62. The coffee powder then enters into the base 1 via the slots 32 and the open bottom of the driving member 3.

It is noted that the diameter of the closed top of the cap 8 is smaller than that of the cap 8 so as to form a shoulder between the closed top and a top portion of the cap 8. An aperture 81 is defined through the closed top. Multiple blocks 82 extend from the shoulder. The cap 8 has a cone-shaped inner space 83 defined therein, and the aperture 81 communicates with the tip portion of the cone-shaped inner space 83.

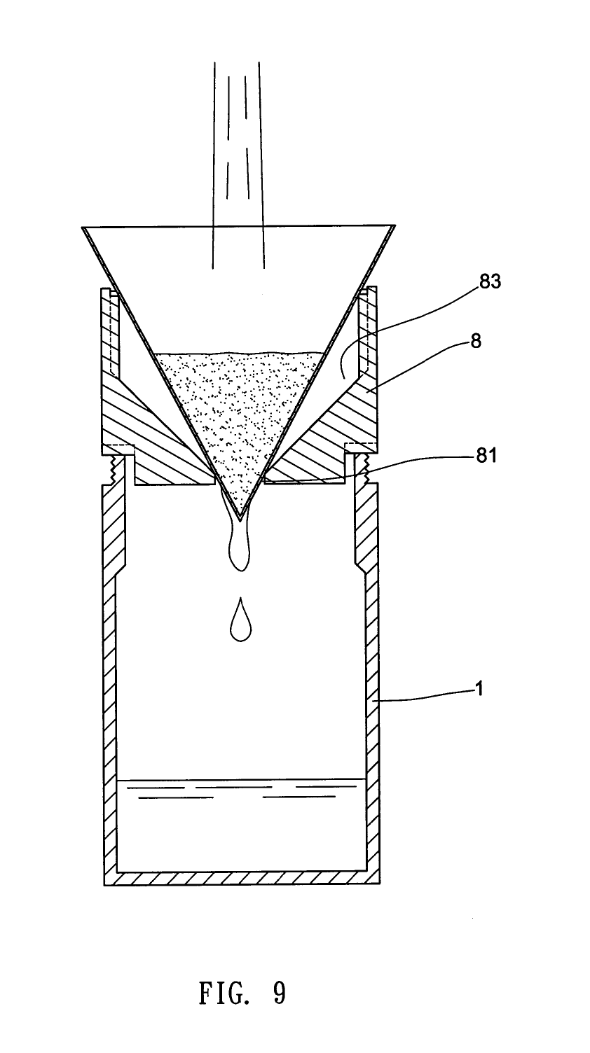

After the coffee powder is ground, the coffee powder is removed from the base 1 to a cone-shaped filter. The cap 8 is reversely mounted to the open top of the base 1, the blocks 82 contact the top edge of the base 1 and multiple gaps are defined between the top edge of the base 1 and the shoulder of the cap 8. Theses gaps are used as air release paths. As show in FIG. 9, the filter and the coffee powder are put in the cone-shaped inner space 83, and hot water is poured to the coffee powder in the filter to make coffee which then drains into the base 1. The base 1 is used as a coffee cup to enjoy the coffee. No electric power is needed for grinding the coffee beans.

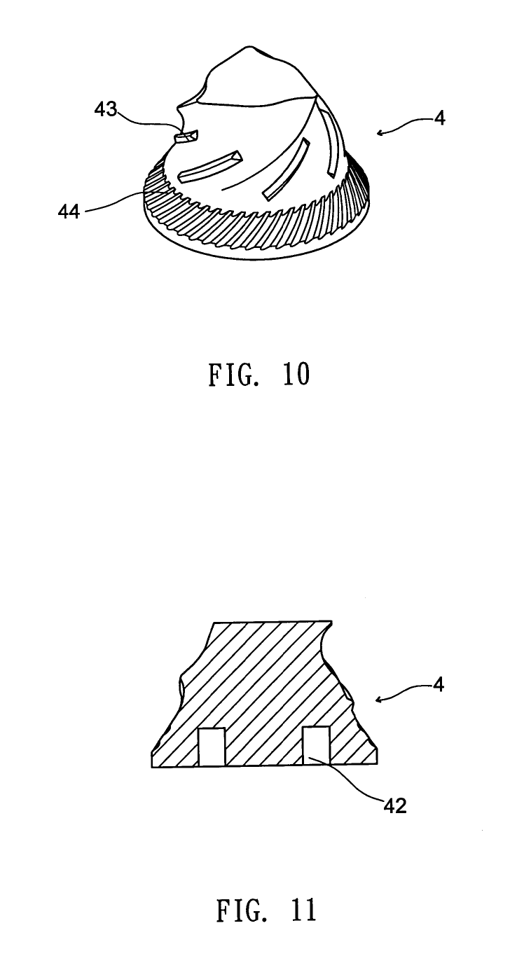

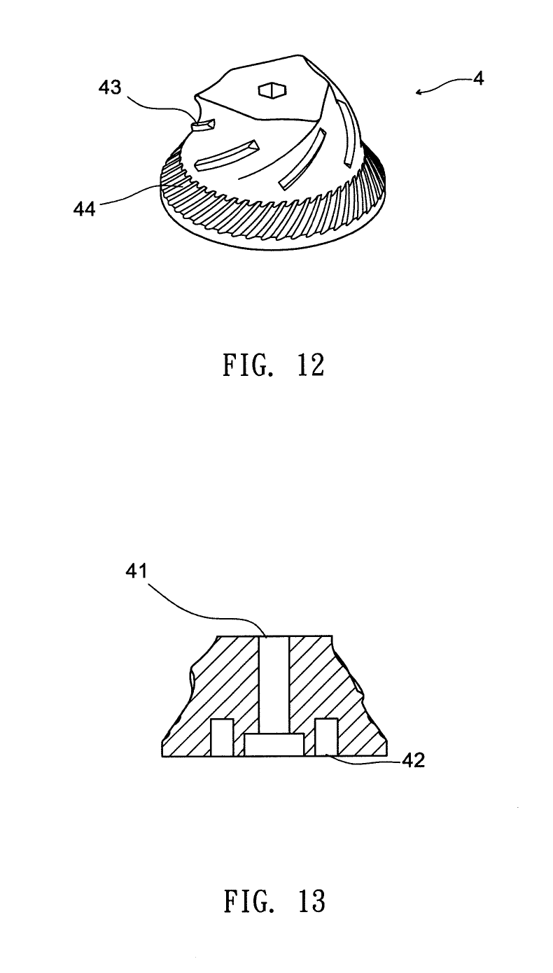

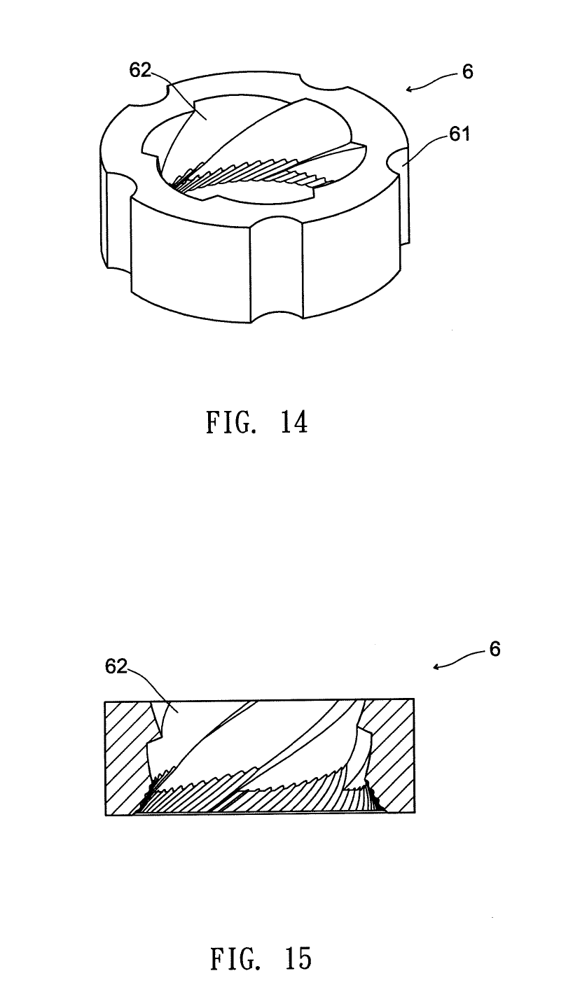

FIGS. 10 and 11 show that male grinder 4 does not have a cleaning passage 41 for an expandable function purpose as disclosed in FIGS. 12 and 13. FIGS. 14 and 15 show that the patterns of the third grinding pieces 62 may be made according to requirements of pre-set functions.

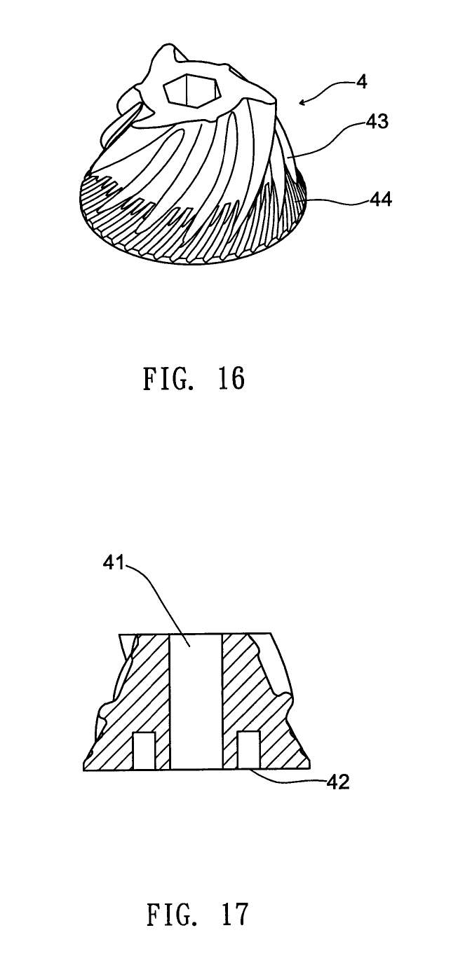

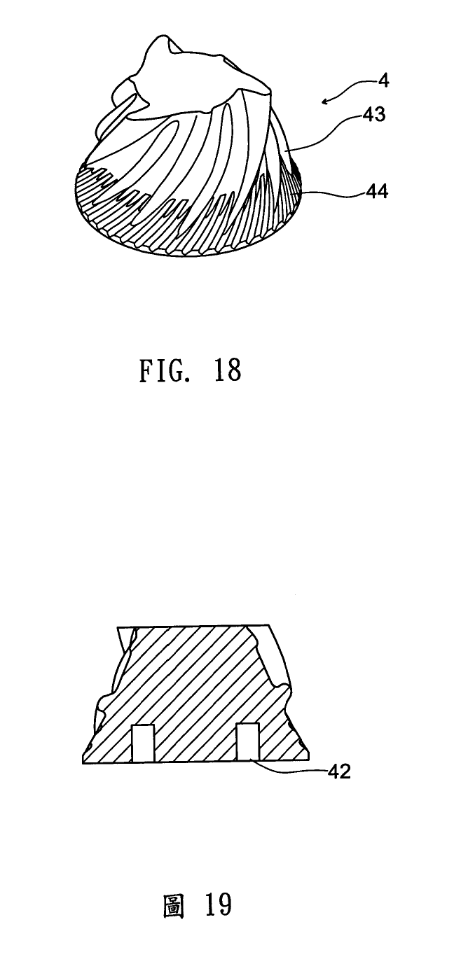

FIGS. 16 to 19 show another patterns of the first and second grinding pieces 43, 44, wherein the male grinder 4 in FIGS. 16 and 17 has the cleaning passage 41 for an expandable function purpose, while the male grinder 4 in FIGS. 18 and 19 does not have the cleaning passage 41 for an expandable function purpose.

The coffee cup assembly of the present invention has a grinding device for grinding coffee beans without need of electric power. The user can choose the desired gap between the male and female grinders 4, 6 to grind the coffee beans. When the touch face 72 is adjusted to directly touch the female grinder 6, this means that the female grinder 6 cannot be pushed upward so that the gap between the male and female grinders 4, 6 to grind the coffee beans is set. By this way, the user can get the desired coffee powder. When the touch face 72 is adjusted to keep a distance from the top of the female grinder 6, the female grinder 6 can be pushed upward relative to the male grinder 4 by the coffee beans of larger size. When the coffee beans of smaller size are to be ground, due to the gravity, the female grinder 6 is located close to the male grinder 4 so that the gap is adjusted to be smaller to grind the coffee beans of smaller size.

While we have shown and described the embodiment in accordance with the present invention, it should be clear to those skilled in the art that further embodiments may be made without departing from the scope of the present invention.

What is claimed is:

1. A coffee grinding device comprising:
a base (1) having an open top and a closed bottom, multiple first threads (11) defined in an outside of a top end of the base (1), a first engaging portion (12) defined in an inner periphery of the top end of the base (1);
a tubular part (2) having multiple second threads (21) defined in an inner periphery thereof and being located above a lower end of the tubular part (2), multiple third threads (24) defined in the inner periphery of the lower end of the tubular part (2), a flange (23) extending from the inner periphery of the tubular part (2) and located between the second threads (21) and the third threads (24), the third threads (24) of the tubular part (2) engaged with the first threads (11) of the base (1);
a driving member (3) having an open bottom, a second engaging portion (36) being formed on an outer periphery of the driving member (3), a support surface (31) transversely formed in a top section of the driving member (3), multiple slots (32) defined through the support surface (31) and communicating with the open bottom, a third engaging portion (34) extending from a top of the support face (31), a skirt portion (37) extending outward from the outer periphery of the driving member (3), a diameter of the skirt portion (37) being larger than that of the second engaging portion, the driving member (3) inserted into the tubular part (2) and an underside of the skirt portion (37) rested on the flange (23) of the tubular part (2);
a male grinder (4) having a fourth engaging portion (42) defined in an underside thereof, the fourth engaging portion removably engaged with the third engaging portion of the driving member (3), the male grinder (4) having a tapered surface on an outer periphery thereof, multiple first grinding pieces (43) extending from the tapered surface, when the base (1) is rotated, the driving member (3) is rotated by the base (1), and the male grinder (4) is rotated by the driving member (3) without central principal axis;
a collar (5) having multiple fourth threads (52) defined in an outer periphery thereof, the collar (5) being received in the tubular part (2) by engaging the fourth threads (52) with the second threads (21) of the tubular part (2), the collar (5) located above the driving member (3), the collar (5) having a fifth engaging portion (51) defined in an inner periphery thereof;
a female grinder (6) having a sixth engaging portion (61) formed on an outer periphery thereof, the female grinder (6) received in the collar (5), the sixth engaging portion (61) of the female grinder (6) slidably engaged with the fifth engaging portion of the collar (5), the female grinder (6) having third grinding pieces (62) formed in an inner periphery thereof, a gap defined between the male grinder (4) and the female grinder (6), when the tubular part (2) is rotated, the collar (5) is driven by the tubular part (2), and the female grinder (6) is rotated by the collar (5);
a threaded tube (7) having fifth threads (71) defined in an outside thereof and having a touch face (72) defined in an underside thereof, the fifth threads (71) engaged with the second threads (21) of the tubular part (2), the touch face (72) adjustably touching a top of the female grinder (6), the threaded tube (7) having a seventh engaging portion (74) defined in the outside thereof, and
a cap (8) having a closed top and an open bottom, an eighth engaging portion (84) formed on an inside of the cap (8) and removably engaged with the seventh engaging potion (74) of the threaded tube (7), a gap between the touch face (72) and the female grinder (6) is adjusted by rotating the cap (8).

2. The coffee grinding device as claimed in claim 1, wherein the first engaging portion include multiple ridges (12) extending from the inner periphery of the base (1), the second engaging portion includes multiple recesses (36) defined in the outer periphery of the driving member (3), the ridges (12) are engaged with the recesses (36).

3. The coffee grinding device as claimed in claim 1, wherein the third engaging portion includes multiple rods (34), the fourth engaging portion includes multiple reception holes (42) in which the rods (34) are inserted, a tolerance is formed between each rod (34) and the reception hole (42) corresponding thereto.

4. The coffee grinding device as claimed in claim 1, wherein the fifth engaging portion includes multiple protrusions (51), the sixth engaging portion includes multiple grooves (61) with which the protrusions (51) are engaged.

5. The coffee grinding device as claimed in claim 1, wherein the seventh engaging portion includes two locking recesses (74), the eighth engaging portion includes two ribs (84) which are engaged with the locking recesses (74).

6. The coffee grinding device as claimed in claim 1, wherein the cap (8) has multiple insertions (85) extending axially from the open bottom thereof, the tubular part (2) has multiple notches (22) defined in a top edge thereof, the insertions (85) are engaged with the notches (22).

7. The coffee grinding device as claimed in claim 1, wherein the female grinder (6) is axially movable along the fifth engaging portion of the collar (5), the male grinder (4) is surrounded by the female grinder (6), the gap defined between the male grinder (4) and the female grinder (6) is adjustable when the female grinder (6) is moved along the fifth engaging portion of the collar (5).

8. The coffee grinding device as claimed in claim 1, wherein a diameter of the closed top of the cap (8) is smaller than that of the cap (8) so as to form a shoulder between the closed top and a top portion of the cap (8), an aperture (81) defined through the closed top, multiple blocks (82) extend from the shoulder, when the cap (8) is reversely mounted to the open top of the base (1), the blocks (82) contact a top edge of the base (1) and multiple gaps are defined between the top edge of the base (1) and the shoulder of the cap (8).

9. The coffee grinding device as claimed in claim 1, wherein the male grinder (4) is rotated without central principal axis.

10. The coffee grinding device as claimed in claim 1, wherein the male grinder (4) has second grinding pieces (44) formed on the tapered surface thereof, the first grinding pieces (43) are located above the second grinding pieces (44).

11. The coffee grinding device as claimed in claim 10, wherein a number of second grinding pieces (44) is more than a number of the first grinding pieces (43).

12. The coffee grinding device as claimed in claim 1, wherein the female grinder (6) includes multiple grooves (61) defined axially in the outer periphery of the female grinder (6).

13. The coffee grinding device as claimed in claim 1, wherein the male grinder (4) includes multiple reception holes (42) defined in the underside thereof.
